(19) United States
(12) Patent Application Publication
(10) Pub. No.: US 2010/0099068 A1
(43) Pub. Date: Apr. 22, 2010

(54) ITEM MANAGEMENT SYSTEM

(75) Inventors: Brian Jean Armagost, Maple Grove, MN (US); Mark Gedlinske, Plymouth, MN (US)

Correspondence Address: SCHWEGMAN, LUNDBERG & WOESSNER, P.A., P.O. BOX 2938, MINNEAPOLIS, MN, 55402, US

(73) Assignee: Data Recognition Corporation, Maple Grove, MN (US)

(21) Appl. No.: 12/579,189

(22) Filed: Oct. 14, 2009

Related U.S. Application Data
(63) Continuation of application No. 11/331,451, filed on Jan. 11, 2006, now abandoned.
(60) Provisional application No. 60/643,075, filed on Jan. 11, 2005.

(51) Int. Cl. G09B 3/00

(52) U.S. Cl. 434/322

(57) ABSTRACT

The present subject matter relates to a system for generating documents for testing and surveys. The system in various embodiments provides for generating and managing an electronic item bank The system provides for generation, administration, analyses, and processing of tests and surveys formed from items in the item bank Wherein an item includes information stored in a data structure to serve as a common source for the information for that particular item.

### CLAIM OF BENEFIT AND INCORPORATION BY REFERENCE

This application is a continuation of U.S. patent application Ser. No. 11/331,451, filed Jan. 11, 2006, which claims the benefit under 35 U.S.C. Section 119 of U.S. Provisional Patent Application Ser. No. 60/643,075 filed Jan. 11, 2005, which applications are incorporated by reference.

### FIELD OF THE INVENTION

The present subject matter relates to systems for testing and surveys.

### BACKGROUND

The generation of test or survey items to create test or survey forms is a complicated task. Information for generation of a single test or survey includes a variety of sources and may have different text and graphics combinations. Consistent generation of such tests is difficult and human intervention is needed to ensure that the printed test does not include printing errors and/or inconsistencies.

There is a need in the art for a system for testing and surveys which provides repeatable, predictable, and consistent document generation.

### SUMMARY

The present subject matter addresses the foregoing issues and those not mentioned herein. The present subject matter provides a system for document generation for testing and surveys. The system uses a single source approach for item information to improve the quality and reliability of document generation for testing and surveys. The present subject matter relates to a system for generating and managing an electronic item bank and to generation, administration, and processing of tests and surveys based on the item bank.

This Summary is an overview of some of the teachings of the present application and not intended to be an exclusive or exhaustive treatment of the present subject matter. Further details about the present subject matter are found in the detailed description and appended claims.

### BRIEF DESCRIPTION OF THE FIGURES

FIG. 1 shows one system for generating documents according to one embodiment of the present subject matter.

FIGS. 2-10 show a number of demonstration screens for an item management system according to one embodiment of the present subject matter.

FIG. 11 is a flow diagram of a process for generating documents according to one embodiment of the present subject matter.

FIG. 12 is a diagram showing item banking tools according to one embodiment of the present subject matter.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description provides examples, and the scope of the present invention is defined by the appended claims and their equivalents.

It should be noted that references to “an”, “one”, or “various” embodiments in this disclosure are not necessarily to the same embodiment, and such references contemplate more than one embodiment.

This application claims the benefit of U.S. provisional patent application Ser. No. 60/643,075 filed Jan. 11, 2005, which is incorporated by reference in its entirety.

The present subject matter relates to a system for generating documents for testing and surveys. In various embodiments, the present system provides method and apparatus for managing an electronic item bank.

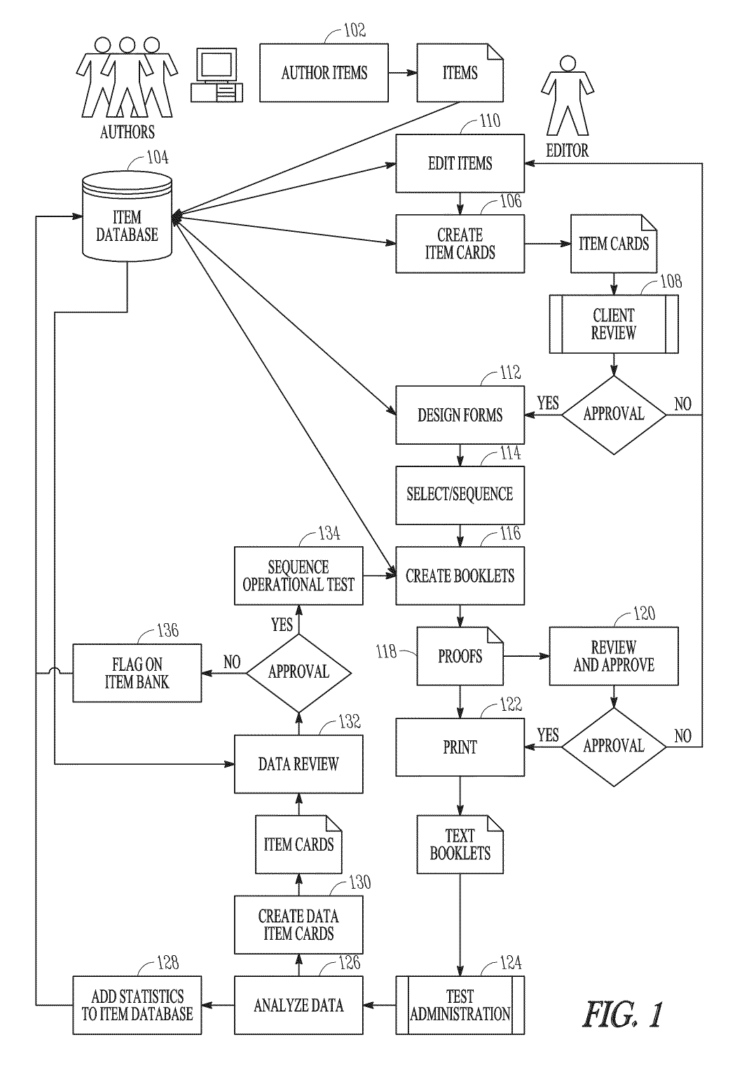

FIG. 1 shows one example of a system for generating and managing an electronic item bank according to one embodiment of the present subject matter. In one embodiment, authors create test items (for example, test questions) 102. The items are stored in an item database 104. The items can be made available to the client by any number of means, including, but not limited to creating item cards 106 for client review 108. If the items are not approved, they may be edited 110 and stored in the item database 104. If the items do meet approval, they can be used to design a form 112 in a desired sequence 114 for test booklets 116. It is understood that the present system can be embodied in electronic forms of communication. Thus, in various applications, items need not be reduced to item cards, but can be transferred and/or reviewed in electronic form. Accordingly, test booklets” in various embodiments, are in electronic form, such as those provided by computer screens. Other presentations may be provided without departing from the scope of the present subject matter. Once test booklets are constructed as proofs 118, they can be reviewed for approval 120. If not satisfactory, the product can be edited 110. If satisfactory, in embodiments incorporating a physical booklet, the booklet is printed 122. In embodiments where electronic means are used to provide the test, any form of electronic publication may be employed.

After a test is administered 124 the system uses data from the testing to evaluate items in the data review step. Data cards are created with the item 132 and its statistical performance for review 132. Data analysis 126 is performed to provide statistics 128 to item database 104. The analysis 126 can also provide input on use of test items 130 for review 132 and approval. Items which are approved will be used to generate an operational test 134 and booklets are created 116. If not approved, then items can be flagged 136 in the item database 104. Flagged items may be rejected for generating a future test.

A number of different permutations of the foregoing acts can be performed without departing from the scope of the present subject matter. In various embodiments, throughout the process, there are several versions of edits, several reviews (where additional changes may be made), and several types of reports printed. Once test items are finalized and approved for “field testing” (where the item is tested on a population of test-takers), the test items may be grouped and sequenced in test booklets.

Test booklets consist of test items in defined groupings, and defined sequences. There may be several versions (or forms) for a test. These may have the same set of items, a different set of items, or a combination of common and unique items. Each time a test question is printed or displayed, it will substantially match the approved item in format and composition.

The processes described herein and their variations include, but are not limited to, applications concerning paper-based and electronic forms of testing.

An item may consist of several components, including, but not limited to: a prompt, a stem, graphics, a passage, answer options, a distractor rationale, item characteristics (for example item ID, skill levels, item type, grade, content, learning standard, and others), and statistics (for example, p-value, point biserial correlation, DIF, logit difficulty, among others). Other components may be included without departing from the scope of the present subject matter.

In various embodiments, the different information in a test item is stored in a single data structure. One embodiment employs XML to group all of the information into a single data structure. The same structure is used in both the item development stage and the item publication stage. This allows for a higher quality booklet, in shorter time, and without conversion issues. Such a system allows for embodiments which are fully integrated, having a seamless process from item authoring through publications and printing. The effect is to make a system which is easier to use with efficient flow for time saving and producing high quality documents. Such a system is adaptable for both paper and non-paper (electronic) applications.

In various embodiments, the system includes one source for items, forms, graphics, and keys. It provides a streamlined process with a structured document that maintains integrity. Some embodiments provide robust capabilities for, among other things, versioning, tracking, security, multiple item types, and search and analysis, for example. In various embodiments, screen labels align with MDE terminology. In various embodiments, web-based solutions allow for MDE access.

The present subject matter addresses one or more of the problems encountered in prior systems, including, but not limited to the following:
1. There are multiple steps and multiple tools used in each step. This requires re-keying of information or translation of information. Often, there must be multiple copies of the item or item components (such as graphics), so that all needs are met. Multiple versions increase the likelihood of errors, or that the copies will not remain “in synch”.
2. There are multiple tools in place for each stage in the overall process. Some authors write items on paper, and others use a range of software tools, such as Word, WordPerfect, InDesign, Illustrator, Corel, Quark, PageMaker, FrameMaker, QuickSilver or other tools. Generally, items are edited or redone in “common” tools. This requires re-entry of information, and introduces the possibility of error.
3. Handling graphics and multimedia is especially troublesome, due to the variety of tools and formats available. Sometimes a graphic must be in a certain format (such as JPEG) for electronic display, and then in PDF format for printing. It may be difficult to maintain exact copies of the graphics as the format is changed.
4. Items are generally authored in an “unstructured” format, where all item information is simply entered on a document. There is no automated way to accurately identify the item prompt, the distractors, the graphics or the item characteristic information.
5. After the review process, when the item is considered “approved”, the process of preparing test forms or booklets begins. Often, this process is a publications process that requires a re-keying of all (or part) of the item information. It is possible to introduce errors, or change the format of the item or associated graphics.
6. As the forms are prepared for printing, final proofs are reviewed. If changes are made, there is typically not an automated way to change the “master” version of the item. It may be possible that the printed version of the item does not agree with the item information in the item bank At this point, there are multiple “master” copies of this item.

The present system is useful for addressing a variety of aspects of item authoring. For example, typically, test items (test questions) are authored by various item authors. These authors may be in numerous locations, including their home. Authors will use a variety of methods for creating a test question. Some will enter using desktop software (such as word processing and graphics programs), and others may write or draw on paper. Test items may include a test question (prompt), answers, rationale for incorrect answers, graphics, diagrams, multimedia components, and simulations or interactions. Test items also include various item characteristics, such as grade, subject, and teaching standard. Once these items are created, they are ready for the editing stage.

Item editing can be done with greater ease using the present system. For example, items may be edited by content specialists or editing staff. This may include revising any portion of the item, or creating additional graphics or multimedia. Once the items have been edited, they are ready for review.

Each test item may undergo several reviews, including reviews for bias and content. These review sessions may be at various locations, including the client's site or some meeting location. As input to these reviews, the complete set of information for an item are printed (sometimes in “Item Card” format), or grouped for electronic presentation and review. During the review processes, the item may be changed. Each change must be logged and tracked, with comments and rationale for each change. The customer may want to see the item exactly as the test taker will see it.

Form design, in varying embodiments, may take place using different approaches. In various embodiments, items are grouped together to create test forms. Each form will have one or more items, sequenced appropriately. There may be several versions (or forms) for a test. These may have the same set of items, a different set of items, or a combination of common and unique items. Each time a test question is printed or displayed, the format and composition are intended to exactly match the approved item. If a word in the test item is bolded, for example, all displays and representations of that item are intended to have the identical bolding. Graphics are intended appear in the size and format approved through the review process. Other forms layout information may be included, such as graphics, timing tracks or registration marks. Once the form layouts are completed, the forms are printed or readied for electronic presentation.

Various embodiments provide for printed documents. The first stage in printing is to produce a “proof' or “blue-line” copy of the documents. This proof is reviewed. If changes are identified, they are made, and the review process repeated. Test booklets and materials are printed.

In various embodiments, after the test is administered, data are collected regarding the performance of the individual items (for example, but not limited to, a number of students getting the item correct, a number of times each incorrect answer is selected, among others). These statistical data then become part of the overall information about the item. Also tracked will be a history of every time an item is used on a test, including the form and sequence in which it existed. If an item is identified as a bad or flawed item, it is flagged so that it will never be used again.

In post-testing, several clients may publish certain items as samples or practice items. Once an item is released to the public, a record needs to be made of this, and usually the item is not used on a test again.

The present subject matter includes an Item Management System. In one embodiment, this system is an integrated process (from Item Authoring, through Editing and Review, and ending with printed test booklets or booklets formatted for electronic presentation).

In one embodiment, we have found benefits to a single repository for all information relating to an item. All editing, formatting, and printing will use that one source.

One way to implement the solution is through the use of “structured documents”, which will identify the several components of item information. A current technique for identifying the structure of information includes, but is not limited to XML.

Some benefits of the present approach and system include ease-of-use and flexibility. Various embodiments include input screens (and output reports) that can easily be modified to fit the customer's needs. For example, some states have “learning standards” and others have “benchmarks”. Our input and output formats will have labels that match the customer's terminology. Some embodiments provide robust tracking of edits to items, and comments from reviews. Some embodiments keep each instance or version of an item, and will always know the current version.

Some embodiments provide item security and access security. For example, such systems may provide online and other access to item information, and this will be role-based. For example, editors may have capabilities that a committee review person may not. Other features, such as limiting access so that certain items will be available only to specified people are available in various embodiments. Embodiments affording web-based access will employ security structures so the item's information and integrity is maintained.

In various embodiments, all printing and displaying of items will display the one source of information. This avoids the possibility of an item appearing differently on an Item Card, test booklet, statistical summary or progress report. If changes are made just prior to printing, these changes are made to the one source of the item. In this way, the printed (or displayed) test items will always match the item information stored in the item management system.

It is understood that multiple item types can be managed by this solution, including multiple choice items, extended response, constructed response, multimedia, interactive items, and simulations.

For web-based applications it will be possible to conduct electronic item reviews at remote sites. During committee reviews, for example, changes may be made to the item information, and these will apply to the one source of that item.

The integrated, end-to-end process reduces manual steps, multiple tools, and re-keying of information—and results in built-in quality, and time reduction.

Since the entire system is integrated, a robust set of management information is available, including the number of items at each step in the process, and an exact accounting for each item.

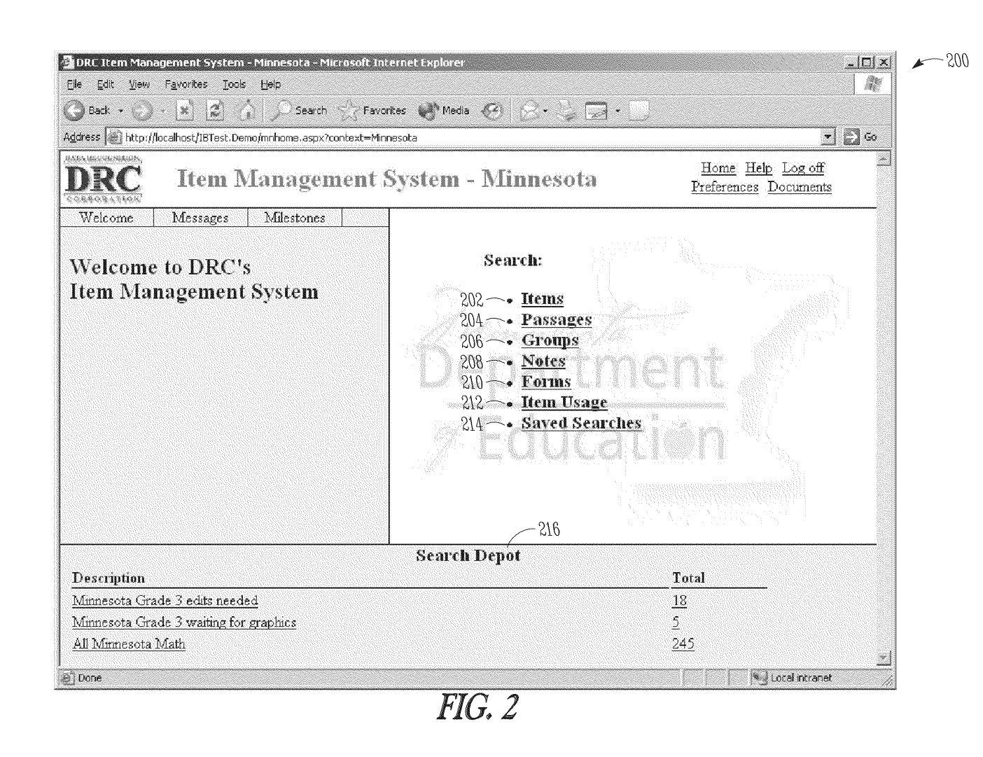

FIGS. 2-10 show a number of demonstration screens for an item management system according to one embodiment of the present subject matter. For example, FIG. 2 shows a screen 200 according to one embodiment of the present system which provides means for searching items 202, passages 204, groups 206, notes 208, forms 210, item usage 212, and saved searches 214. It also provides a search depot 216 which can be used to provide a variety of matters, such as items to be developed. In one embodiment, screen 200 is customized for the individual viewing the screen. In various embodiments, the screen can be presented as a function of, among other things, the particular user, the user's department, the user's company, and the user's title or position. Thus, in such embodiments, the items shown in the search depot 216 can also be a function of such aspects of the user, to name a few.

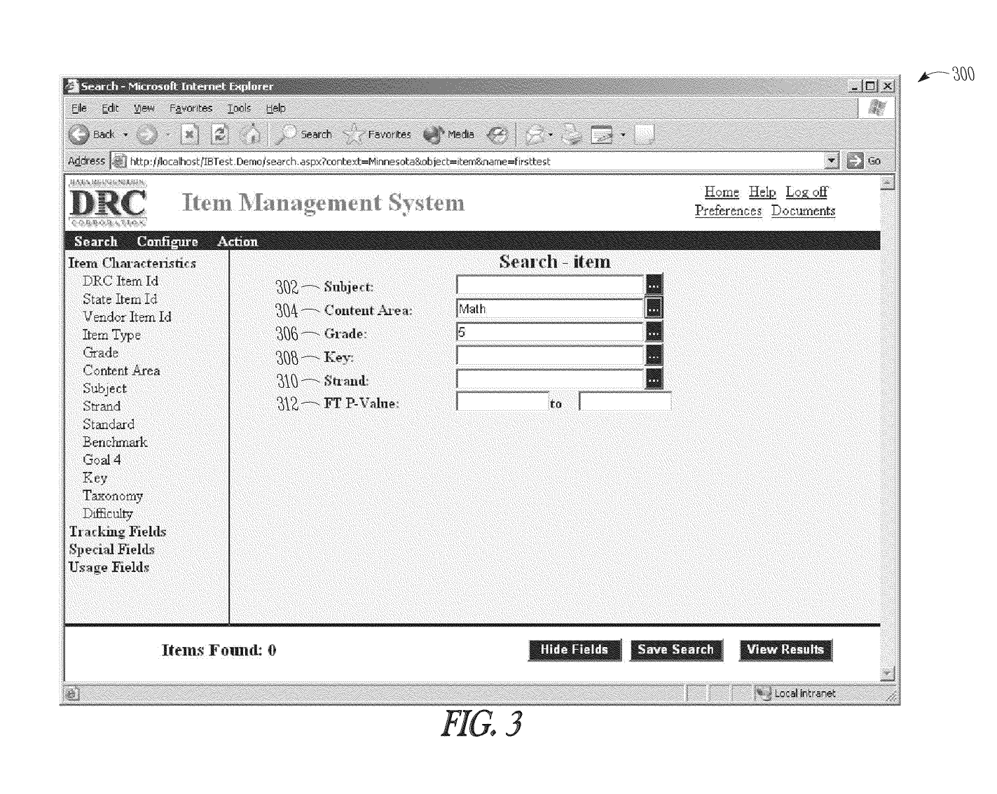

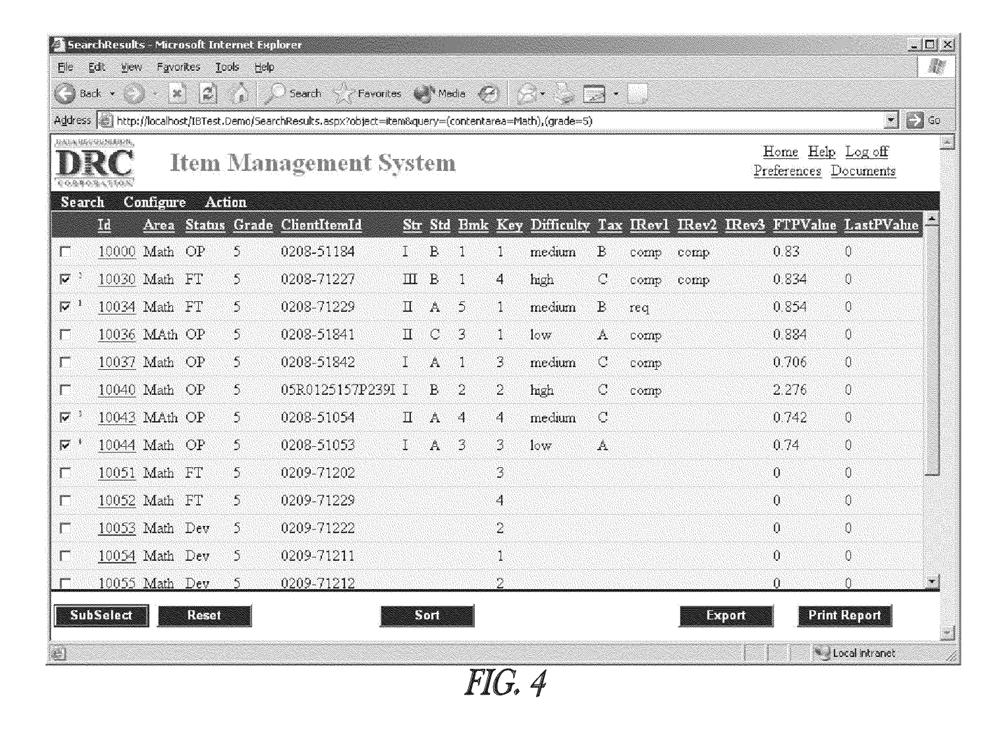

FIG. 3 shows a screen 300 according to one embodiment of the present system. Screen 300 shows various fields for conducting searches. The fields include, but are not limited to, subject 302, content area 304, grade 306, key 308, strand 310, and FTP-value 312. In the example shown in FIG. 3, a search is conducted for math as the content area and for 5^{th} grade. The screen can be customized for other search fields if desired. Fields can be hidden if desired. Searches may be saved. FIG. 4 shows a screen listing the results of the screen of FIG. 3 to demonstrate

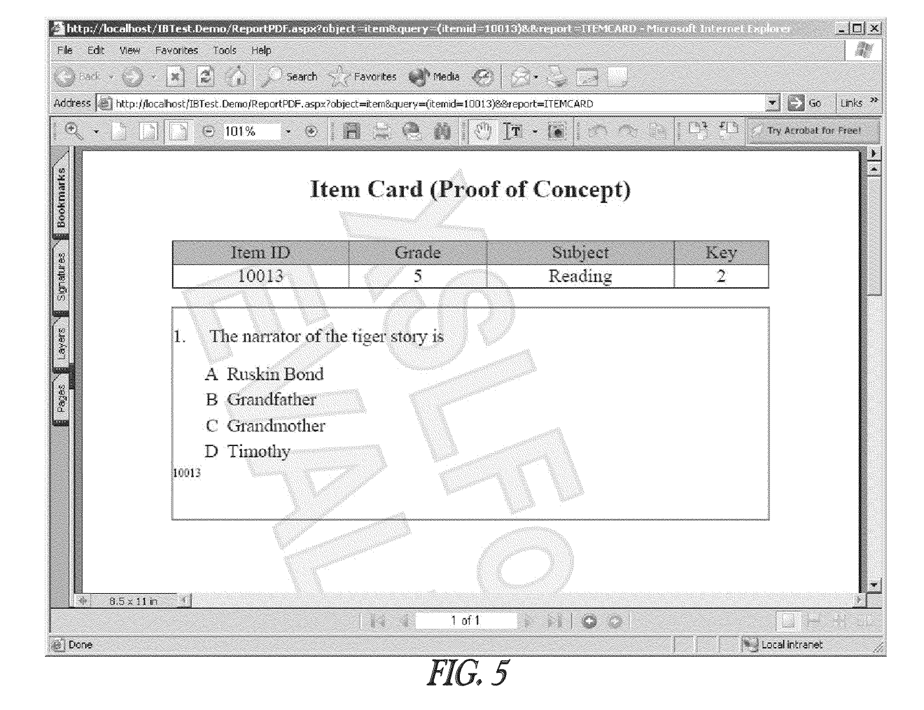

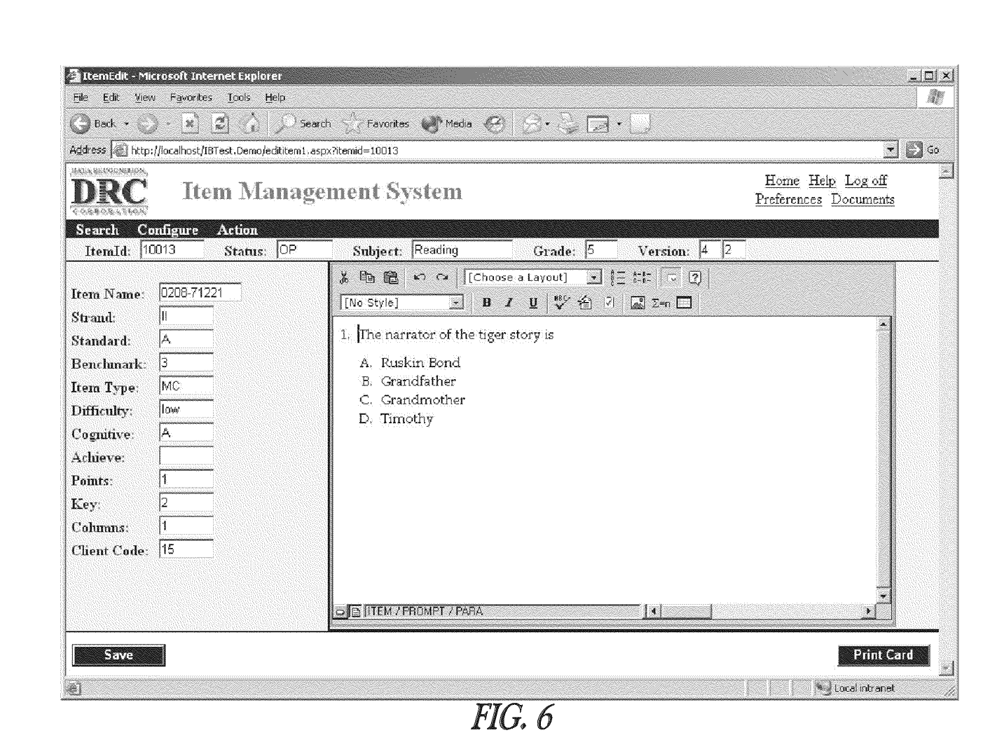

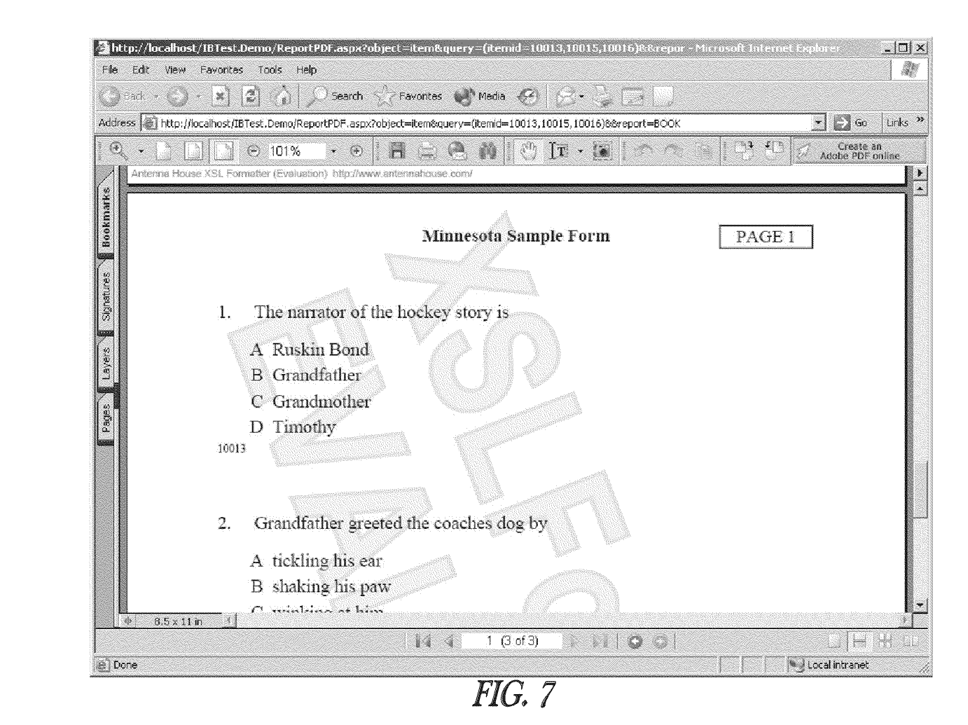

FIGS. 5 and 6 show an example of an item card with ItemID 10013, according to one embodiment of the present subject matter. FIG. 7 shows use of the example item card from FIGS. 5 and 6 in a test format with other questions, according to one embodiment of the present subject matter.

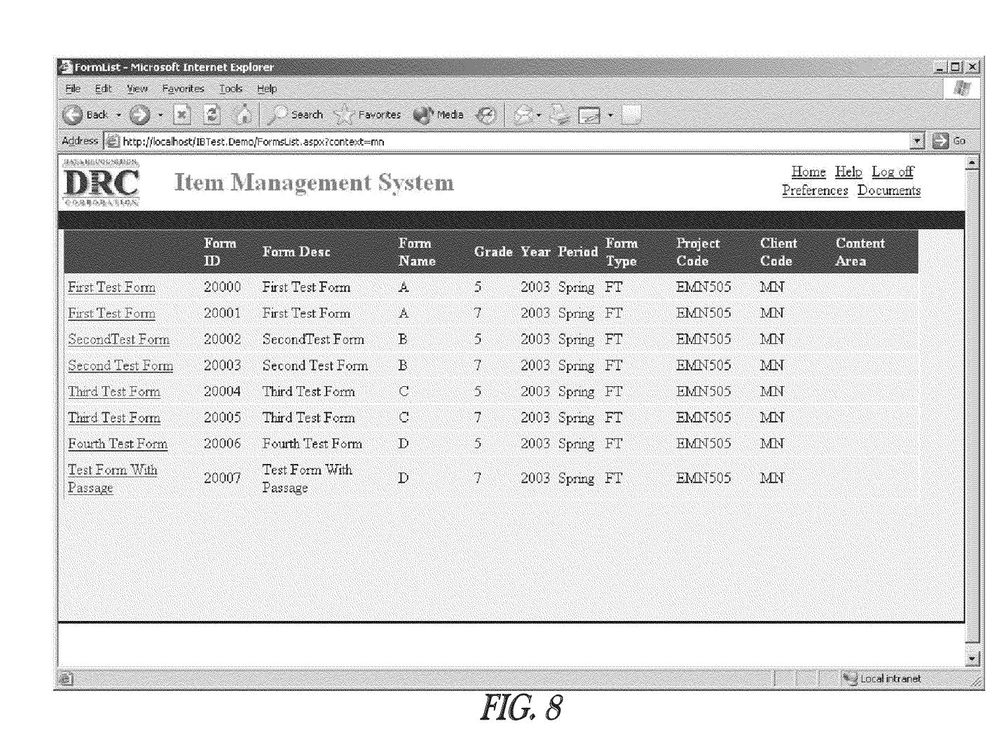

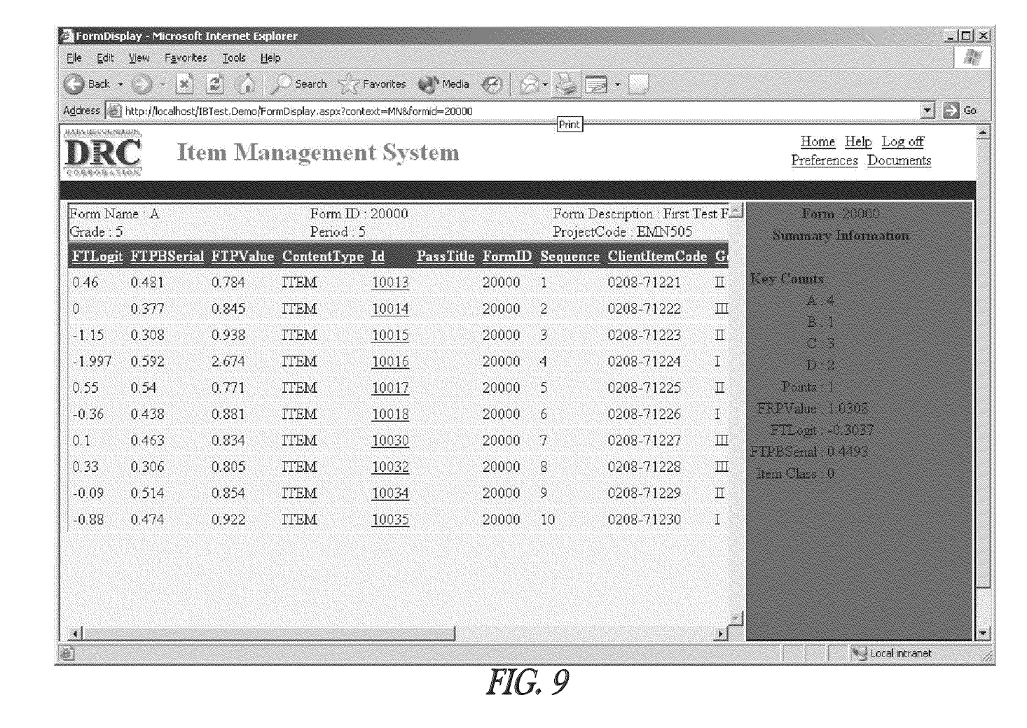

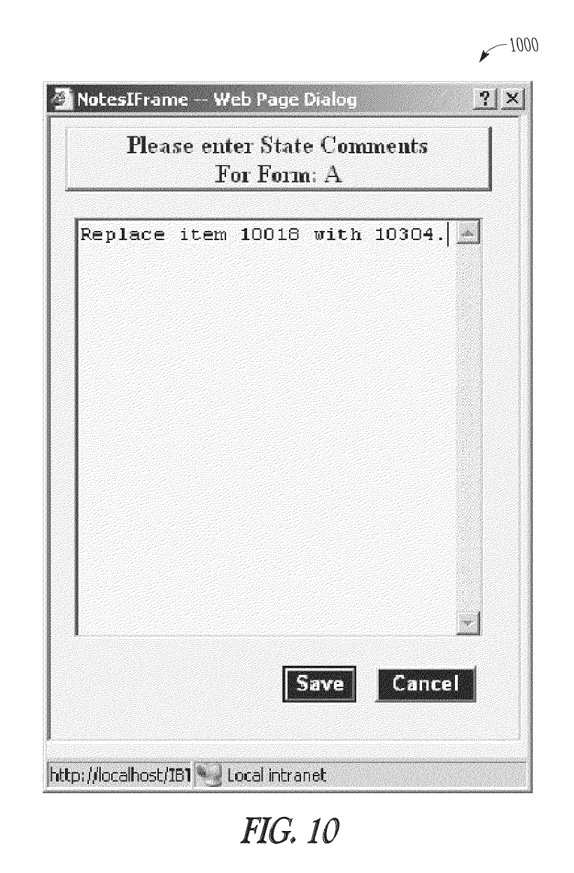

FIG. 8 shows a listing of test forms and form ID as associated with other fields, such as description, form name, grade, year, period, form type, project code, client code, and content area, according to one embodiment of the present subject matter. FIG. 9 shows a breakdown of the items in the form having Form ID 20000 on an item by item basis, according to one embodiment of the present subject matter. FIG. 10 shows a comments input for a particular form (e.g., Form A), according to one embodiment of the present subject matter.

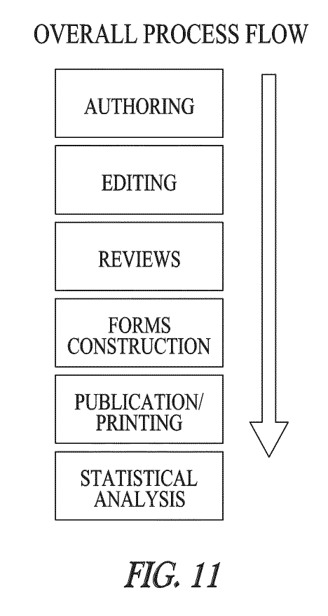

FIG. 11 is a flow diagram of a process for generating documents according to one embodiment of the present subject matter. The acts of authoring, editing, reviews, forms construction, publications/printing, and statistical analysis are shown in a particular order, however, it is understood that order may vary and that intervening acts may be performed without departing from the scope of the present subject matter.

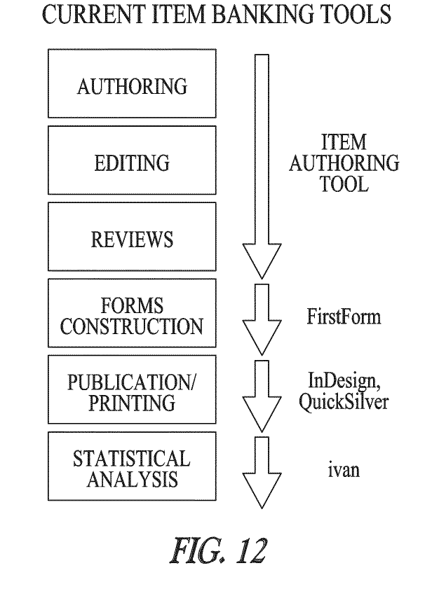

FIG. 12 is a diagram showing item banking tools according to one embodiment of the present subject matter. The acts of FIG. 11 are repeated herein and associated with different applications to demonstrate one possible version of item banking tools; however, it is understood that different tools may be used without departing from the scope of the present subject matter.

It is to be understood that the above description is intended to be illustrative, and not restrictive. Screens may vary without departing from the teachings provided herein. Applications and fields may also vary. Other embodiments will be apparent to those of skill in the art upon reviewing and understanding the above description. The scope of the invention should, therefore, be determined with reference to the appended claims, along with the full scope of equivalents to which such claims are entitled.

What is claimed is:

1. A method, comprising:
authoring a plurality of items for use in standardized testing;
storing the plurality of items in an item bank, each item having its information stored in an individual data structure serving as a single source of the information for that item;
publishing test forms using one or more items from the plurality of items;
performing analysis of results from testing using the test forms; and
editing at least item of the one or more items including updating the individual data structure serving as the single source of the information for the at least one item using the analysis,
wherein a test form published using the at least one item includes any updating to that at least one item such the at least one item will be a unitary source of all edits and format of the at least one item.

2. The method of claim 1, further comprising:
using an XML data structure to hold the information of each item of the plurality of items.

3. The method of claim 1, wherein the items include text and graphics.

4. The method of claim 1, further comprising printing one or more tests using the plurality of items, wherein any updating of the individual data structure is directly reflected in the one or more tests printed after the updating.

5. The method of claim 1, further comprising providing online access of one or more surveys.

6. The method of claim 1, wherein the publishing includes providing access to test forms online.

7. The method of claim 1, wherein the publishing includes printing forms on paper.

8. The method of claim 1, wherein storing the plurality of items in an item bank includes storing a plurality of multiple choice test questions.

9. The method of claim 1, wherein storing the plurality of items in an item bank includes storing a plurality of answer options for multiple choice test questions.

10. The method of claim 1, further comprising printing a plurality of standardized tests using the plurality of items, wherein any updating of the individual data structure is directly reflected in the plurality of standardized tests printed after the updating,
wherein the data structure is an XML data structure, and
wherein the method is performed as an integrated, end-to-end process that prints the plurality of standardized tests.

11. The method of claim 10, wherein the items include text and graphics.

12. The method of claim 10, wherein the publishing includes providing access to test forms online.

13. The method of claim 10, wherein the publishing includes printing forms on paper.

14. The method of claim 10, wherein storing the plurality of items in an item bank includes storing a plurality of multiple choice standardized test questions.

15. The method of claim 10, wherein storing the plurality of items in an item bank includes storing a plurality of answer options for multiple choice standardized test questions.

16. The method of claim 1, wherein publishing includes providing online access to standardized tests using the plurality of items, wherein any updating of the individual data structure is directly reflected in the standardized tests displayed after the updating,
wherein the data structure is an XML data structure, and
wherein the method is performed as an integrated, end-to-end process that provides online access to the standardized tests.

17. The method of claim 16, wherein the items include text and graphics.

18. The method of claim 16, wherein the publishing includes printing forms on paper.

19. The method of claim 16, wherein storing the plurality of items in an item bank includes storing a plurality of multiple choice standardized test questions.

20. The method of claim 16, wherein storing the plurality of items in an item bank includes storing a plurality of answer options for multiple choice test questions.
